(19) United States
(12) Patent Application Publication
(10) Pub. No.: US 2026/0307310 A1
(43) Pub. Date: Oct. 8, 2026

(54) METHOD FOR MANUFACTURING A MULTILAYER COMPONENT

(71) Applicant: ElringKlinger AG, Dettingen (DE)

(72) Inventor: Thomas Wolf, Dettingen (DE)

(73) Assignee: ElringKlinger AG, Dettingen (DE)

(21) Appl. No.: 19/629,165

(22) Filed: Mar. 26, 2026

(30) Foreign Application Priority Data
Apr. 8, 2025 (DE) 10 2025 113 771.4

(51) Int. Cl. B29C 45/14; H01M 50/126; B29L 31/00

(52) U.S. Cl. CPC B29C 45/14811; B29C 45/14065; B29C 45/1418; H01M 50/126; B29L 2031/7146

(57) ABSTRACT

A method comprising: providing a first and second cover layer element in a mold unit, at least one of the cover layer elements having a first and second surface ply element that are arranged next to and/or fastened to each other, directly, there being one or more through-holes realized in the second surface ply element; and introducing a plastic material between the first and the second cover layer element , during the introduction of the plastic material, plastic material being introduced through the one or more through-holes between the first and the second surface ply element and/or being brought into contact with the first surface ply element, as a result of which the plastic material in the region of the one or more through-holes of the second surface ply element realizes a respective fixing section for fixing at least one of the surface ply elements to the core element.

### RELATED APPLICATION

This application claims the benefit of German application No. 10 2025 113 771.4 filed on Apr. 8, 2025, which is incorporated herein by reference in its entirety and for all purposes.

### FIELD OF DISCLOSURE

Round The present invention relates to a method for manufacturing a multilayer component, in particular for a battery housing and/or an underride guard system.

Furthermore, the present invention relates to a multilayer component, in particular for a battery housing, to a battery housing and to mold unit for manufacturing a multilayer component.

### BACKGROUND

Multilayer components are widely used in various industrial sectors, including automotive engineering, aviation and aerospace as well as electrical engineering, where there are stringent requirements regarding the properties of components, such as, for example, regarding the component weight and/or corrosion resistance and/or mechanical load capacity and/or installation space efficiency, as well as regarding the manufacturing processes, such as, for example, their efficiency and/or costs.

The present invention is based, in particular, on the object of providing a method for manufacturing a multilayer component so as to enable multilayer components to be manufactured preferably more efficiently and/or in particular with improved component properties.

### SUMMARY OF THE INVENTION

This object is achieved according to the invention by the features of the independent claim. Advantageous developments are described in the dependent claims.

A method according to the invention for manufacturing a multilayer component comprises at least the following:
providing a first and a second cover layer element in a mold unit, at least one of the cover layer elements having a first and a second surface ply element that are arranged next to and/or fastened to each other, in particular directly, there being one or more through-holes realized in the second surface ply element; and
introducing a plastic material between the first and the second cover layer element for the purpose of producing a core element of the multilayer component, and, during the introduction of the plastic material, plastic material being introduced through the one or more through-holes between the first and the second surface ply element and/or being brought into contact with the first surface ply element, as a result of which the plastic material in the region of the one or more through-holes of the second surface ply element realizes a respective fixing section for fixing at least one of the surface ply elements to the core element.

It may be provided that the multilayer component, in particular sandwich component, is configured for lightweight construction applications and/or for use, e.g. assembly, in lightweight construction parts and/or lightweight construction assemblies and/or lightweight construction structures.

It may be provided that the multilayer component is realized as a covering element. For example, this covering element may serve as an additional protective element and/or be realized as such, in which case the additional protective element may cover one or more components and/or assemblies of a higher-level system, e.g. vehicle and/or energy storage unit. For example, the additional protective element may be realized as an underride guard element of an underride guard system.

It may preferably be provided that the multilayer component is configured for an underride guard system, or the underride guard system, and/or for a housing for an energy storage unit, in particular a battery, for example a rechargeable battery. For example, the multilayer component may be configured for an underride guard system, or the underride guard system, and/or for a battery housing. For example, the multilayer component may be part of such a housing and/or may be realized as an underride guard element, or the underride guard element, e.g. underbody guard element.

It may be provided that the multilayer component has at least one, for example one or more, intermediate layer, which is arranged between the cover layer elements and realizes and/or is the core element.

For example, the intermediate layer and/or intermediate layers and/or the core element may comprise the said plastic material and/or may be producible or produced from this plastic material, in particular by means of introduction of the plastic material between the first and the second cover layer element.

It may be provided that a respective intermediate layer has a material state. It is conceivable, for example, for the material state of one or more intermediate layers to be substantially the same as, or different from, a material state of a further intermediate layer or of a plurality of further intermediate layers.

It may be provided, for example, that the multilayer component has a plurality of intermediate layers, the respective material state of which is the same, or where the material state of at least one of the intermediate layers is different from a material state of at least one other of the intermediate layers.

For example, at least one of the plurality of intermediate layers may have a first material state and at least two of the plurality of intermediate layers may have a second material state that is different from the first material state, and it may preferably be provided that the intermediate layer having the first material state is arranged between the intermediate layers having the second material state.

For example, the first material state may be a foamed state and/or have a foam phase and/or the second material state may be in a non-foamed state and/or have substantially no foam phase.

Additionally or alternatively, the first material state may have a lesser density than the second material state, and/or the second material state may have a greater density than the first material state.

It may be provided, for example, that between the said intermediate layers having differing material states there is a transition, in particular a continuous transition, between the material states. For example, in the continuous transition, a density may continuously increase or decrease and/or a foam phase may continuously increase or decrease.

It may be provided that at least one of the cover layer elements or each cover layer element has a first and a second surface ply element that are arranged next to and and/or fastened to each other, in particular directly.

It may preferably be provided that there are one or more through-holes realized in the second surface ply element.

For example, the through-holes in the second surface ply element may be realized at regular and/or irregular distances from each other.

For example, the through-holes in the second surface ply element may be realized at regular and/or irregular distances from each other and in a matrix-like arrangement.

It may be provided, for example, at least one through-hole is realized in the first surface ply element and corresponds to one of the through-holes in the second surface ply element, for example in such a way that their longitudinal central axes substantially coincide. Preferably, these through-holes arranged in a mutually corresponding manner may serve to receive a mold element, preferably to hold at least one of the cover layer elements in the mold unit.

It may be provided, for example, that at least a first and a second surface ply element are provided on at least one of the cover layer elements.

For example, at least one of the cover layer elements may have two or more surface ply elements that are arranged next to and and/or fastened to each other, in particular directly.

Preferably, through-holes arranged in a mutually corresponding manner may be provided in each of the surface ply elements, in particular for the purpose of receiving a mold element, preferably for holding at least one of the cover layer elements in the mold unit.

It may be provided, for example, that a cover layer element is plate-like and/or plate-shaped, in particular before the plastic material has been and/or is introduced between the first and the second cover layer element.

In particular, it may be provided that a cover layer element or at least a part thereof is arranged on the outside in the multilayer component, for example as part of the multilayer component, and/or is directed outwardly, for example facing in a direction that is oriented transversely and in particular perpendicularly with respect to a plane bounded by main directions of extent of the multilayer component.

Additionally or alternatively, it may in particular be provided that a cover layer element or at least a part thereof is realized in the multilayer component, for example as part of the multilayer component, as an uppermost and/or a lowermost ply.

It may preferably be provided that the first surface ply element of a cover layer element in the multilayer component is arranged on the outside and/or is directed outwardly. Additionally or alternatively, it may in particular be provided that the first surface ply element of a cover layer element in the multilayer component is realized as an uppermost and/or a lowermost layer.

It may be provided, for example, that the first surface ply element of a cover layer element in the multilayer component forms an outer peripheral surface and/or at least a part thereof of the multilayer component.

It may be provided that the first and the second cover layer element are configured identically and/or similarly with respect to each other or are configured differently with respect to each other.

It may be provided that a fixing section realizes a form-fit connection to the second surface ply element.

It may additionally or alternatively be provided that the second surface ply element is partially or wholly surface-treated, preferably mechanically surface-treated, and that the fixing section realizes a form-fit connection to this second surface ply element. For example, the second surface ply element may be surface-treated on one or both sides, for example roughened and/or microstructured. Preferably, this may be the surface of the second surface ply element that faces away from the first surface ply element when they are arranged against each other.

It may additionally or alternatively be provided that the second surface ply element is provided with an adhesion promoter, and the fixing section realizes a materially bonded connection to this second surface ply element.

For example, a surface of the second surface ply element may be and/or is coated with the said adhesion promoter, in particular before being provided. Preferably, this may be the surface of the second surface ply element that faces away from the first surface ply element when they are arrange against each other. In particular, it may be conceivable that the adhesion promoter can be applied or is applied by spraying, rolling and/or dipping. This may optionally be followed by a drying and/or curing process. Preferably, the adhesion promoter may be adapted to the chemical structure and/or processing properties of said plastic material.

It may additionally or alternatively be provided that the fixing section realizes a form-fit and/or materially bonded connection to the first surface ply element.

It may be provided that a fixing section corresponds to at least one through-hole and/or can be assigned or is assigned to at least one through-hole. It is also conceivable that a fixing section corresponds to two or more of the through-holes and/or can be assigned or is assigned to them.

It may be provided, for example, that a fixing section has at least one retaining region that is oriented transversely and in particular perpendicularly with respect to a direction of extent of a through-hole, in particular of a corresponding and/or assignable and/or assigned through-hole, preferably of the through-hole through which plastic material is introduced between the first and the second surface ply element and/or is brought into contact with the first surface ply element.

In particular, it may be provided that the at least one retaining region serves to enable and/or realize the said form-fit connection to the second surface ply element and/or the said form-fit and/or materially bonded connection to the first surface ply element.

It may be provided that, following the introduction of the plastic material, an intermediate space between the first and the second cover layer element is filled with plastic material, and a fixing section engages behind the second surface ply element with respect to the intermediate space.

It may be provided, for example, that the fixing section is arranged at least partially on and/or at a lateral face of the second surface ply element that faces away from the intermediate space.

In particular, it may be provided that the intermediate space is and/or becomes at least partially or completely filled with plastic material, and/or the intermediate space is filled with the one or more intermediate layers and/or the core element, and/or these are accommodated in the intermediate space.

It may be provided that a fixing section extends away from the intermediate space, in particular in a direction of extent that is transverse and in particular perpendicular with respect to a surface extent of the first and/or the second cover layer element and/or of the first and/or the second surface ply element.

It may be provided that the mold unit has at least two mold sections by which a cavity can be realized that determines the outer contour for the multilayer component, and the cavity has one or more cavity protrusions and/or one or more cavity recesses that substantially determine the outer contour for the fixing sections.

It may be provided, for example, that the first and the second cover layer element are fixed jointly on one of the mold sections, in particular during provision.

For example, this may be effected when the mold unit is in an equipping state.

For example, the mold unit may be movable between an open state and a closed state, whereby an equipping state of the mold unit corresponds to and/or is the open state and/or whereby, in the closed state, the plastic material can be introduced into the mold unit and preferably between the cover layer elements.

It may be provided, for example, that the one or more cavity protrusions and/or the one or more cavity recesses protrude and/or recess along a direction that is oriented transversely and in particular perpendicularly with respect to a longitudinal central plane of the cavity of the mold unit.

It may be provided that a fixing section is substantially mushroom-like and/or mushroom-shaped and/or substantially rivet-like and/or rivet-shaped.

It may additionally or alternatively be provided that a fixing section is realized substantially as a structural element and/or functional structure.

It is conceivable, for example, for a structural element to serve to reinforce the multilayer component and/or to mount the multilayer component in a higher-level assembly.

It is conceivable, for example, for a functional structure to serve to arrange a fastening element, e.g. a screw, and/or a sensor means and/or to feed through electrical conductor elements.

It may additionally or alternatively be provided that a fixing section is substantially rib-like and/or realized as a rib.

It may additionally or alternatively be provided that a fixing section is substantially flange-like and/or realized as a flange.

It may be provided that a fixing section has been and/or is produced wholly and/or integrally from the plastic material.

It may additionally or alternatively be provided that a fixing section is integrally connected to and/or realized with the one or more intermediate layers and/or the core element.

It may be provided that, before the first and the second cover layer element are provided in the mold unit, the second surface ply element is joined, preferably by layering, to the first surface ply element, or the second surface ply element is joined, preferably by layering, to the first surface ply element by means of and/or during the introduction of the plastic material.

It may be provided, for example, that before the first and/or the second cover layer element is provided in the mold unit, the second surface ply element of the first and/or the second cover layer element is joined, preferably by layering, to the corresponding first surface ply element, or the second surface ply element of the first and/or the second cover layer element is joined, preferably by layering, to the corresponding first surface ply element by means of and/or during the introduction of the plastic material.

It may be conceivable, for example, for the second surface ply element to be joined to the first surface ply element by a process, and in particular by layering, that may comprise, for example, a laminating process and/or an overlaying process and/or an adhesive bonding process and/or a tempering process and/or a pressure application process.

For example, the first and/or the second surface ply element may have at least one self-adhesive surface, in particular on one side, and/or an adhesive and/or an adhesion promoter may be applied, in particular on one side, to the first and/or the second surface ply element for the purpose of joining the surface ply elements to each other.

It may be conceivable, for example, for the second surface ply element to be joined to the first surface ply element, and in particular by layering, on the basis of a temperature prevailing in the mold unit that is correspondingly adapted to the first and/or the second surface ply element.

It may be conceivable, for example, for the second surface ply element to be joined to the first surface ply element, and in particular by layering, with the introduced plastic material joining, preferably by material bonding, to the first surface ply element.

It may preferably be provided that the first surface ply element at least partially comprises and/or is formed from a material that corresponds substantially to the plastic material and/or that can be joined to the plastic material by material bonding.

It may be provided that the second surface ply element is realized as a flexurally rigid element and/or comprises such an element.

In particular, it may be provided that the second surface ply element comprises a flexurally rigid material and/or is or can be produced from such a material.

It may additionally or alternatively be provided that the second surface ply element is realized as a sheet element and/or comprises such an element.

In particular, it may be provided that the sheet element of the second surface ply element is a metallic sheet, in particular a steel sheet or sheet containing aluminum.

It may be provided that the one or more through-holes in the second surface ply element(s) is/are produced by mechanical and/or thermal and/or abrasive means. Mechanical processes may include, for example, drilling and/or punching. Thermal processes here may include, for example, laser cutting, or laser drilling, and/or plasma cutting and/or autogenous cutting. Abrasive processes may include, for example, water-jet cutting.

It is understood that the present method may comprise one or more corresponding process steps to produce the one or more through-holes. For example: producing and/or realizing one or more through-holes in a second surface ply element, or the second surface ply element, of the first and/or the second cover layer element, or for the first and/or the second cover layer element. Preferably, such a process step may be effected before the first and second surface ply elements are joined together.

It may additionally or alternatively be provided that the first surface ply element is realized as and/or comprises an elastic and/or plastically deformable and/or stretchable element.

In particular, it may be provided that the first surface ply element comprises an elastic and/or plastically deformable and/or stretchable material and/or is produced or can be produced from such a material.

It may additionally or alternatively be provided that the first surface ply element is realized as a sheet element or film element and/or comprises such an element.

In particular, it may be provided that the sheet element of the first surface ply element is a plastic sheet, in particular a thermoplastic sheet, and/or a fiber composite sheet, in particular an organic sheet and/or tape and/or sheet element formed from tapes.

For example, the thermoplastic sheet may be a polyethylene sheet, or PE sheet, and/or a polyethylene plate, or PE plate. Other thermoplastics may also be conceivable here, such as, for example, polypropylene, or PP, polyamides, or PA (e.g. PA6, PA66, etc.), etc.

For example, the fiber composite sheet may be produced from a fiber-reinforced plastic. For example, the plastic comprised by the fiber composite sheet may be in contact with surfaces of fibers. For example, the fibers may preferably be embedded in the plastic comprised by the fiber composite sheet, impregnated with the plastic or arranged on a surface of the plastic. It may be provided, for example, that the fibers run unidirectionally or multidirectionally, e.g. bidirectionally. It may be provided, for example, that the fibers comprise polymer fibers, for example aramid fibers and/or polyacrynitrile fibers, carbon fibers and/or mineral fibers, for example glass fibers.

In particular, it may be provided that the film element of the first surface ply element is a plastic film element, in particular a thermoplastic film element.

For example, the thermoplastic film element may be a polyethylene film element, or PE film element. Other thermoplastics may also be conceivable here, such as, for example, polypropylene, or PP, polyamides, or PA (e.g. PA6, PA66, etc.), etc.

It may be provided that introducing of the plastic material, injecting of the plastic material and/or spraying-in of the plastic material and/or spray-foaming of the plastic material and/or an injection molding of the plastic material comprises and/or is/are the same process(es).

It may be provided, for example, that the plastic material is introduced by means of injection molding, in particular compact injection molding and/or foam injection molding, for example "MuCell®" injection molding, and/or expansion injection molding, and/or introduction by means of foam injection, for example polyurethane foam injection.

It may be provided that the plastic material, and in particular the plastic material to be introduced, is a fluid plastic material.

Additionally or alternatively, it may be provided that the plastic material, and in particular the plastic material to be introduced, is a plastic material in a plastic state.

Additionally or alternatively, it may be provided that the plastic material, and in particular the plastic material to be introduced, is a plastic material heated above an associated softening temperature.

Additionally or alternatively, it may be provided that the plastic material, and in particular the plastic material to be introduced, is a molten plastic material.

Additionally or alternatively, it may be provided that the plastic material, and in particular the plastic material to be introduced, is a reaction-driven and/or reactive plastic material that comprises, in particular, two or more reaction components that preferably can be brought into reaction with each other.

It may additionally or alternatively be provided that the plastic material is a thermoplastic and/or thermosetting plastic material.

It may be provided, for example, that the plastic material comprises and/or is polyurethane. For example, the plastic material in the manufactured multilayer component may be a polyurethane foam, and/or the plastic material may comprise and/or be one or more starting components for a polyurethane foam.

It may be provided, for example, that the plastic material comprises and/or is a polyolefin material.

It may be provided, for example, that the plastic material comprises and/or is a polyethylene, polypropylene, polyphenylene ether, polyphthalamide, polyphenylene sulfone, polyether ether ketone, polysulfone, polyamide, polybutylene terephthalate and/or polystyrene, and/or combinations of at least two of these elements.

It may be provided, for example, that the plastic material comprises and/or is a resin, for example a polyurethane resin, a polyamide resin or a combination of these resins.

It may additionally or alternatively be provided that a gas and/or a gas mixture is supplied to the plastic material during the introduction of the plastic material, which is thus foamed. It may be provided, for example, that a certain material state, in particular the first material state already described, may be made possible and/or realized in this way. It may additionally or alternatively be provided that the plastic material comprises one or more filler components and/or that these are added thereto. For example, a filler component may be and/or comprise a glass-based, carbon-based and/or mineral-based filler component. For example, a filler component may comprise glass fibers and/or glass (hollow) beads and/or carbon fibers and/or mineral aggregates, such as calcium carbonate, magnesium silicate, aluminum silicate, silica, mica, and/or aluminum hydroxide. For example, the one or more filler components may make up a proportion of the plastic material, and/or be contained therein, of greater than 0 to 75% by weight, in particular of greater than 0 to 65% by weight, for example greater than 0 to 60% by weight. As an alternative to greater than 0 as a lower limit, it may be conceivable here, for example, that greater than or equal to 10% by weight, in particular greater than or equal to 20% by weight, for example greater than or equal to 30% by weight, is provided.

It may additionally or alternatively be provided that the method also comprises cooling the introduced plastic material and/or allowing it to cool; and moving the mold sections in mutually opposite directions, in particular away from each other, for the purpose of realizing a foamed intermediate layer of the multilayer component.

For example, the cooling and/or allowing to cool may relate to peripheral regions of the core element and/or relate to regions located adjacent to the second surface ply element.

For example, the foamed intermediate layer may be arranged and/or realized in the intermediate space and/or in the core element and/or along a, or the, longitudinal central plane of the cavity of the mold unit.

The foamed intermediate layer may, in particular, have the first material state already described.

The cooled regions of the introduced plastic material may, in particular, have the second material state already described.

In the case of an alternative design, it may be provided that the first and/or the second cover layer element are formed from or comprise a wood material, for example a veneer.

It may further be provided, in the case of this or one of the other embodiments, that a WPC (wood-plastic composite) material has been or is arranged between the cover layer elements, for example by filling the region between the cover layer elements.

It may be provided that the first and second cover layer elements are arranged on and/or bear against each other, in particular directly, when being provided in the mold unit.

It may additionally or alternatively be provided that the first and the second cover layer element are arranged on and/or bear against each other, in particular directly, when being provided in the mold unit, with in this case each first surface ply element being arranged on the mold side and/or each second surface ply element being arranged facing away from the mold unit, and/or the second surface ply elements of the cover layer elements being arranged facing toward each other, and/or the second surface ply elements of the cover layer elements being arranged on and/or bearing against each other, in particular directly.

It may additionally or alternatively be provided that the first and the second cover layer element are spaced apart from each other before the introduction of the plastic material and/or during the introduction of the plastic material and/or by the introduction of the plastic material.

It may additionally or alternatively be provided that the first and the second cover layer element are spaced apart from each other before the introduction of the plastic material and/or during the introduction of the plastic material and/or by the introduction of the plastic material, enabled by one or more mold elements of the mold unit.

For example, the mold unit has one or more mold elements that enable the first and the second cover layer element to be spaced apart from each other, preferably before the introduction of the plastic material and/or during the introduction of the plastic material and/or by the introduction of the plastic material.

It may be provided, for example, that the first and/or the second cover layer element is/are arranged, in particular supported, adjacent to one or more mold elements of the mold unit, preferably before the plastic material is introduced.

Additionally or alternatively it may be provided, for example, that the first and/or the second cover layer element is/are arranged, in particular supported, in particular directly, on one or more tool elements of the mold unit, preferably before the plastic material is introduced.

For example, the first and/or the second cover layer element may be such that it/they can be held and/or is/are held one or more mold elements of the mold unit, preferably before the plastic material is introduced.

It may be provided, for example, that the first and/or the second cover layer element is/are supported and/or held in a form-fitting and/or force-fitting manner on one or more mold elements of the mold unit, preferably before the plastic material is introduced.

It may be provided, for example, that one or more receivers are provided in and/or on the first and/or second cover layer element.

Such a receiver may be, for example, a recess and/or an opening and/or a through-hole.

For example, a tool element can be brought into engagement with one of these receivers in order to support and/or hold the first and/or the second cover layer element, in particular in a form-fitting and/or force-fitting manner, preferably before the plastic material is introduced.

For example, a mold element may be realized in such a way that it can be brought into engagement with such a receiver.

For example, the receiver may be the through-holes already described, arranged to correspond to each other.

It may additionally or alternatively be provided that the plastic material is introduced between the first and the second cover layer element, with the first and/or the second cover layer element being supported, prior to the introduction, by means of one or more mold elements of the mold unit for the purpose of the spacing apart of the cover layer elements from each other caused by the introduced plastic material.

It may be provided, for example, that the plastic material is introduced between the first and the second cover layer element in that the plastic material is injected and/or sprayed-in and or pressed-in between the cover layer elements, in which case, prior to the injection and/or spraying-in and/or pressing-in, the first and/or the second cover layer element is supported by means of one or more tool elements of the mold unit for the purpose of the spacing apart of the cover layer elements from each other caused by the injected and/or sprayed-in and/or pressed-in plastic material.

It may be provided, for example, that the first and/or the second cover layer element is supported by means of one or more mold elements of the mold unit in order to locally fix and/or hold one of the first and/or the second cover layer element in the mold unit, the other of the first and/or the second cover layer element being movable or moved for the spacing apart of the cover layer elements from each other by the plastic material introduced in the mold unit.

It may be provided that the first and the second cover layer element are provided in a, or the, cavity of the mold unit that determines the outer contour for the multilayer component, and one or more, preferably all, mold elements of the mold unit are moved out of the cavity of the mold unit during the introduction, in particular actively and/or passively, preferably by means of a positioning means and/or as a result of the introduced plastic material.

For example, one or more, preferably all, mold elements may be actively movable out of the cavity of the mold unit by means of the positioning means.

For example, the positioning means may be a pneumatic and/or hydraulic and/or electric positioning means, by means of which one or more, preferably all, mold elements can be moved pneumatically and/or hydraulically and/or electrically.

In addition or alternatively, one or mote, preferably all, mold elements may be passively movable out by the introduced plastic material, preferably enabled by a flexible, in particular resilient, mounting of the mold elements and/or caused by an introduction pressure building up and/or prevailing during the introduction of the plastic material into the cavity.

It may be provided that, before the first and the second cover layer element are provided in the mold unit, the first and the second cover layer element are tempered, preferably preheated.

For example, it may be provided that, before the first and the second cover layer element are provided in the mold unit, the first and the second cover layer element are tempered, preferably preheated, jointly when arranged on and/or bearing against each other, in particular directly.

For example, it may alternatively be provided that, before the first and second cover layer elements are provided in the mold unit, the first and second cover layer elements are tempered, preferably preheated, jointly, in particular individually and/or separately from each other, and then arranged and/or placed next to each other, in particular directly.

For example, such tempering, preferably preheating, may be effected by means of a tempering device, for example an oven.

It may be provided that the first and second cover layer elements are introduced into the mold unit when arranged on and/or bearing against each other, in particular directly, for the purpose of providing the first and second cover layer elements in the mold unit.

In particular, it may be provided that the first and the second cover layer element can be introduced or are introduced into the mold unit substantially transversely and in particular perpendicularly with respect to the direction of gravity or substantially parallel to the direction of gravity.

For example, the first and second cover layer elements may be introducible or introduced into the mold unit in such a way that the direction of gravity is oriented transversely, and in particular perpendicularly, with respect to a plane bounded by the directions of main extent of the cover layer elements, or lies substantially in this plane.

For example, the first and second cover layer elements may be introducible or be introduced into the mold unit in a horizontal or vertical orientation.

It may be provided, for example, that such introduction is and/or comprises insertion or laying-in and/or suspension and/or setting.

The introduction may be effected, for example, in an automated manner, in particular in a fully automated manner, for example by means of a handling device, for example a multi-axis robot, and/or manually, for example by a user.

In the case of an alternative design, it may be provided that the method further comprises: introducing one or more spacers between the cover layer elements, preferably before plastic material is introduced.

For example, the spacers may be introduced by a separate introduction step, e.g. spraying-in and/or foaming-in and/or pressing-in step, of plastic material and/or may be introduced by means of adhesive bonding.

For example, in the case of this alternative design, bondable or bonded-in spacers may comprise wood and/or a honeycomb structural element.

The present invention further provides a multilayer component, in particular for a battery housing.

The multilayer component, in particular for a battery housing, may preferably be manufactured by means of a method as described above and/or below.

All structural and functional features associated with the method described herein and/or embodiments thereof may also be included in the multilayer component according to the invention, either alone or in combination, and the properties, embodiments and advantages associated therewith may accordingly likewise be included and achieved. It is further understood that this also applies to the converse case.

In particular, it may be provided that the multilayer component comprises at least the following:
a first and a second cover layer element, at least one of the cover layer elements having a first and a second surface ply element,
a core element that is arranged between the first and the second cover layer element, and
at least one fixing section for fixing at least one of the surface ply elements to the core element.

It may be provided that the first and second surface ply elements are arranged on and/or fastened to each other, in particular directly, with one or more through-holes being realized in the second surface ply element.

It may be provided that the core element is produced by means of introduction of a plastic material between the first and the second cover layer element.

It may be provided that the at least one fixing section is arranged in the region of the one or more through-holes of the second surface ply element.

It may be provided that the at least one fixing section is produced by means of introduction of a plastic material between the first and the second cover layer element.

It may be provided that during the introduction process the plastic material is introduced between the first and the second surface ply element through the one or more through-holes and/or is brought into contact with the first surface ply element.

It may be preferably be provided that each of the cover layer elements comprises a first and a second surface ply element that are arranged on and/or fastened to one other, in particular directly, with one or more through-holes being realized in the respective second surface ply element.

It may be provided that the first surface ply element in the multilayer component is arranged on the outside, in particular exposed.

It may be preferably be provided that the first surface ply element serves as a protective element, for example for corrosion protection, of the multilayer component and/or is realized as such.

It may additionally or alternatively be provided that the second surface ply element in the multilayer component is arranged on the inside, in particular not exposed.

It may preferably be provided that the second surface ply element serves as a stiffening and/or reinforcing element, for example for load absorption and/or load distribution in the multilayer component, and/or is realized as such.

As already described, it may preferably be provided that the first surface ply element at least partially comprises and/or is formed from a material that corresponds substantially to the plastic material and/or can be materially bonded to the plastic material.

For example, the material of the first surface ply element and the plastic material may be substantially the same material, and preferably the first surface ply element and the plastic material may assume and/or realize a material bond with one other, whereby a continuous and/or one-piece material body may be realizable and/or realized in the multilayer component.

Accordingly, it may be provided, for example, that the second surface ply element is partially or completely surrounded and/or encased by the first surface ply element and the core element.

Preferably, it may therefore be provided that the multilayer component comprises at least the following:
a first and a second cover layer element, one or both of the cover layer elements having a first and a second surface ply element (respectively),
a core element that is arranged between the first and the second cover layer element and is integrally joined to the first surface ply element or the first surface ply element, whereby each second surface ply element is partially or completely surrounded and/or encased by the respective first surface ply element and the core element.

It may be provided in this case, for example, that a region in which a first surface ply element and the core element are joined to one other realizes at least one fixing section for fixing at least one second surface ply element on the core element.

For example, a multilayer component, in particular for a battery housing, for example a part of a battery housing and/or an underride protection element, may be providable or provided, in which at least one surface ply element, in particular a second surface ply element, for example a metallic sheet element, is partially or completely encased by a plastic material.

The present invention further provides a battery housing.

The battery housing may preferably comprise a multilayer component as described above and/or below.

Preferably, the battery housing may be manufactured, in particular at least partially, by means of a method as described above and/or below.

All structural and functional features associated with the method and/or multilayer component and/or embodiments thereof described herein may also be included in the battery housing according to the invention, either alone or in combination, and the properties, embodiments and advantages associated therewith may accordingly likewise be included and achieved. It is further understood that this also applies to the converse case.

It may be provided, for example, that the multilayer component, for example as part of the battery housing, is realized as a tray element and/or in the manner of a tray.

For example, it may additionally or alternatively be provided that the multilayer component, for example as part of the battery housing, is realized as an underride protection element.

It may be provided that the multilayer component forms one of more wall sections of the battery housing.

It may be provided that the wall sections of the battery housing realize a receiving space for receiving one or more battery cells of a battery device, and preferably the receiving space is surrounded on one side and/or on a plurality of sides and/or completely by the wall sections.

The present invention further provides a mold unit for manufacturing a multilayer component.

Preferably, the multilayer component that can be manufactured by means of the mold unit according to the invention may be realized according to the description above or below.

Preferably, this mold unit according to the invention can be used to perform a method according to the description above and/or below.

Accordingly, it may be provided that this mold unit according to the invention is the mold unit that is described in connection with the method according to the description above and/or below.

All structural and functional features associated with the method and/or multilayer component and/or embodiments thereof described herein may also be included in the mold unit according to the invention, either alone or in combination, and the properties, embodiments and advantages associated therewith may accordingly likewise be included and achieved. It is further understood that this also applies to the converse case.

It may be provided that the mold unit has at least two mold sections by which a cavity can be realized that determines the outer contour for the multilayer component.

For example, the mold unit may be selectively movable between an open state and a closed state.

It may be provided, for example, that the first and the second cover layer element can be fixed jointly, in the open state, on one of the mold sections.

It may be provided, for example, that the plastic material can be introduced into the mold unit, and preferably between the cover layer elements, in the closed state.

For example, the mold unit may be such that it can be opened and/or closed in that the mold sections can be brought into a mutual spacing and/or the mold sections can be brought into engagement and/or contact with each other.

For example, the mold unit may be such that it can be opened and/or closed along a direction of actuation.

For example, the direction of actuation may be oriented transversely, and in particular perpendicularly, with respect to the direction of gravity or substantially parallel to the direction of gravity.

For example, the direction of actuation may be oriented transversely, and in particular perpendicularly, with respect to a longitudinal center plane of the cavity of the mold unit.

Preferably, the direction of actuation may be an opening and closing direction.

It may be provided that the mold unit has one or more mold elements that are arranged, and in particular supported, so as to be movable in at least one of the mold sections.

It may be provided, for example, that the one or more mold elements extends/extend into the cavity and/or are movable into the cavity and/or are movable out of the cavity.

It may be provided, for example, that the mold unit, and in particular one of the mold sections, has at least one opening for introducing plastic material into the cavity, in particular an injection and/or spray-in nozzle.

It may be provided that one or more, in particular all, mold elements are actively and/or passively movable, preferably by means of a positioning device.

It is understood that the present invention may further provide a production facility for manufacturing one or more multilayer components. Preferably, this production facility can be used to perform a method according to the description above and/or below. Additionally or alternatively, it may be provided that the production facility comprises a mold unit according to the description above and/or below.

It is further understood that the present invention may also relate to a computer program product comprising instructions that, when the computer program product is executed by a control unit and/or a computing unit, cause the latter to execute a method of the type described above, for example in a production facility, preferably a production facility for manufacturing a multilayer component of the type described above.

The control unit and/or the computing unit may be comprised, for example, by the production plant and/or be assignable to it and/or be connectable to it by means of signal technology.

It is understood that the present invention may also relate to a computer-readable storage medium on which a computer program product described above is stored.

Advantageously, multilayer components, in particular for a battery housing, may be be producible in an efficient manner by means of the method according to the invention, and these components may be suitable, in particular, for lightweight construction.

For example, by means of the present invention, multilayer components, e.g. parts of battery housings and/or underride protection elements, may be provided, these advantageously not requiring complex, separate coatings for corrosion protection and/or adhesion during manufacture, and/or having a high flexural rigidity with the smallest possible installation space, and/or having significantly reduced material and/or process costs. Furthermore, the said multilayer components can be easier to recycle and/or can be manufactured in shorter cycle times with, in particular, simplified processes.

Furthermore, the present invention can provide, for example, a solution that avoids the high material costs and/or component weights associated with conventional battery housings and/or underride guard elements made of steel or aluminum, while at the same time also largely dispensing with complicated hybrid variants, matrix materials that are difficult to recycle and/or cost-intensive coating processes.

Furthermore, for example the improved 3D moldability during the process and/or the cost-efficient process can also make it possible to achieve a greater degree of structural design freedom and/or a reduction in production complexity.

In this way, the present invention can also provide, for example, improvements with regard to installation space, weight, recyclability and/or process costs.

Further preferred features and/or advantages of the present invention are the subject-matter of the following description and the graphical representation of exemplary embodiments.

### BRIEF DESCRIPTION OF THE DRAWINGS

FIG. 1 shows a schematic view of a part of a mold unit according to an exemplary embodiment of the present invention, being in a state during a method according to an exemplary embodiment of the present invention;

FIG. 2 shows a schematic view of the part of the mold unit from FIG. 1, being in a further state during the method;

FIG. 3 shows a schematic view of the part of the mold unit from FIG. 1, being in a yet further state during the method;

FIG. 4 shows a schematic view of the part of the mold unit from FIG. 1, being in a yet further state during the method;

FIG. 5 shows a schematic view of the part of the mold unit from FIG. 1, being in a yet further state during the method;

FIG. 6 shows a schematic view of a multilayer component according to an exemplary embodiment of the present invention;

FIG. 7 shows a schematic view of a multilayer component according to a further exemplary embodiment of the present invention;

FIG. 8 shows a schematic view of a part of a mold unit according to a further exemplary embodiment of the present invention, being in a state during a method according to a further exemplary embodiment of the present invention, and

FIG. 9 shows a schematic view of a multilayer component according to a further exemplary embodiment of the present invention.

In all figures, elements that are the same or functionally equivalent are denoted by the same reference designations.

### DETAILED DESCRIPTION OF THE DRAWINGS

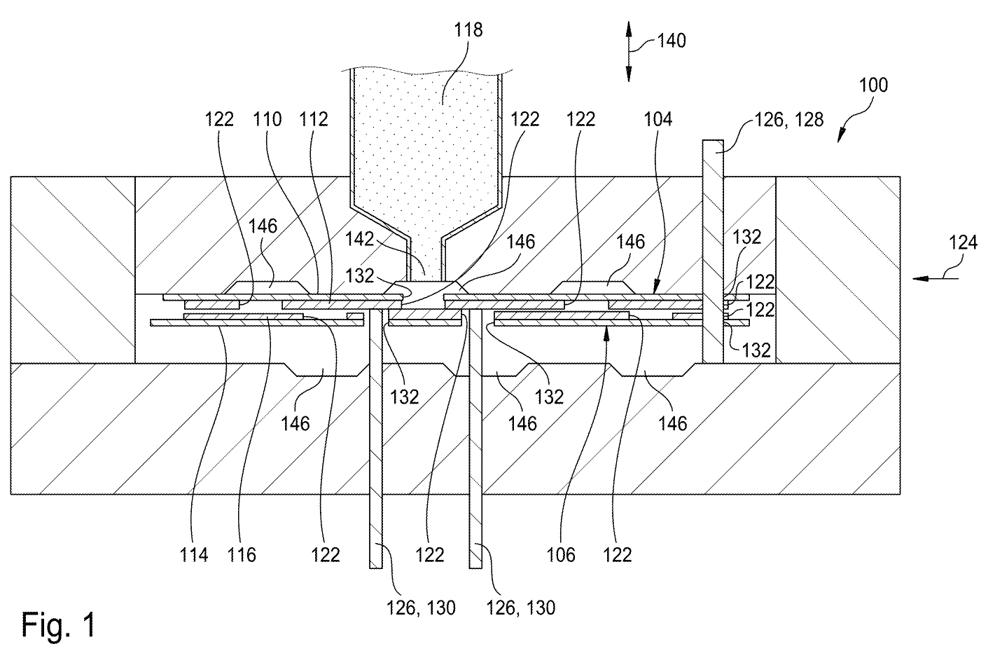

With reference to FIGS. 1 to 5, a method for manufacturing a multilayer component 102 is provided, which can be performed, for example, by use of one of the mold units 100 for manufacturing a multilayer component 102, which are shown respectively in FIGS. 1 to 5 and 8.

Preferably, this mold unit 100 may be comprised by and/or form a part of a production facility for manufacturing a multilayer component 102.

Accordingly, the method may also be such that it can be performed by use of this production facility.

There may further be provided a computer program product comprising instructions that, when the computer program product is executed by a control unit and/or a computing unit, cause the latter to execute the method, for example in the said production facility.

A computer-readable storage medium may also be provided, on which said computer program product is stored.

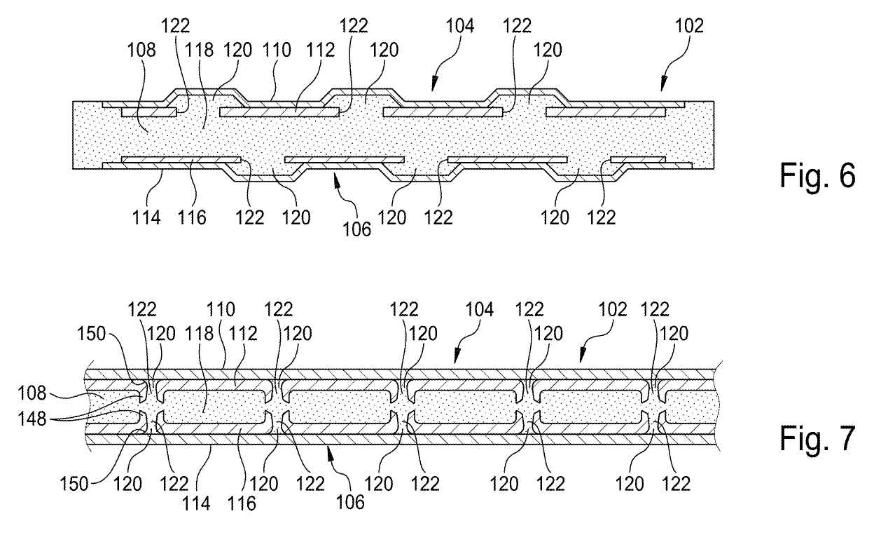

A multilayer component 102 that can be or is produced by the method of FIGS. 1 to 5 is shown schematically in FIG. 6.

The multilayer component 102 may be configured, for example, for lightweight construction applications and/or for use, for example assembly, in lightweight construction parts and/or lightweight construction assemblies and/or lightweight construction structures.

The multilayer component 102 may be configured, for example, for a housing for an energy storage unit, in particular a battery, for example a rechargeable battery, for example a battery housing. For example, the multilayer component may be part of such a housing.

The multilayer component 102 may be, for example, an underride guard element and/or at least a part thereof.

As can be seen in particular in FIG. 6, the said multilayer component 102 has a first cover layer element 104, a second cover layer element 106 and a core element 108.

For example, a cover layer element 104, 106 is plate-like and/or plate-shaped.

The first cover layer element 104 has a first surface ply element 110 and a second surface ply element 112.

The second cover layer element 106 likewise has a first surface ply element 114 and a second surface ply element 116.

A first surface ply element 110, 114 is preferably realized as an elastic and/or plastically deformable and/or stretchable element.

For example, a first surface ply element 110, 114 comprises an elastic and/or plastically deformable and/or stretchable material and/or is or can be produced from such a material.

In the present case, a first surface ply element 110, 114 is realized as a film element.

Alternatively, it is conceivable for a first surface ply element 110, 114 to be realized as a sheet element. In particular, it may be provided that the sheet element of a first surface ply element 110, 114 is a plastic sheet, in particular a thermoplastic sheet, and/or a fiber composite sheet, in particular an organic sheet and/or tape and/or a sheet element formed from tapes.

The film element of a first surface ply element 110, 114 is a plastic film element, for example a thermoplastic film element, in the present case a polyethylene film element, or PE film element.

A second surface ply element 112, 116 is preferably realized as a flexurally rigid element.

For example, a second surface ply element 112, 116 comprises a flexurally rigid material and/or is or can be produced from such a material.

In the present case, a second surface ply element 112, 116 is realized as a sheet element.

The sheet metal element of a second surface ply element 112, 116 is a metallic sheet, for example a steel sheet or a sheet containing aluminum, in the present case a steel sheet.

The core element 108 comprises a plastic material 118 and/or can be or is produced from the plastic material 118.

In the present exemplary embodiment, the plastic material 118 is preferably a thermoplastic plastic material.

In the multilayer component 102, the first surface ply elements 110, 114 are preferably arranged on the outside.

The second surface ply elements 112, 116 are arranged adjacent to the first surface ply elements 110, 114.

The second surface ply elements 112, 116 are arranged on the inside of the multilayer component 102.

The core element 108 is arranged between the second surface ply elements 112, 116.

The core element 108 is thus arranged at least for the most part inside the multilayer component 102.

Lateral peripheral regions of the core element 108 are exposed, for example, relative to the surface ply elements 110, 112, 114, 116.

Furthermore, the multilayer component 102 has at least one fixing section 120.

In the present exemplary embodiment, the multilayer component 102 has a plurality of fixing sections 120.

The fixing sections 120 are realized integrally with the core element 108.

As can be seen in the figures, the second surface ply elements 112, 116 have a plurality of through-holes 122.

The fixing sections 120 are realized here in the region of the through-holes 122 and serve to fix the second surface ply elements 112, 116 to the core element 108.

Exemplary embodiments of the multilayer component 102 are shown schematically in particular in FIGS. 6, 7 and 9.

With reference in particular to FIGS. 1 to 6, in the method for manufacturing the multilayer component 102, the second surface ply elements 112, 116 are first provided and are furnished with the through-holes 122.

For example, the through-holes 122 in the second surface ply elements 112, 116 are produced mechanically and/or thermally and/or abrasively. Mechanical methods here may include, for example, drilling and/or punching. Thermal methods here may include, for example, laser cutting, or laser drilling, and/or plasma cutting and/or autogenous cutting. Abrasive processes here may include, for example, water-jet cutting.

The through-holes 122 are realized, for example, at regular and/or irregular distances from each other.

The through-holes 122 are realized, for example, at regular and/or irregular distances from each other and in a matrix-like arrangement.

The through-holes 122 are preferably circular and/or have a circular cross-section. Other shapes of the through-holes 122, or of their cross-sections, for example, may also be conceivable.

After the through-holes 122 have been made in the second surface ply elements 112, 116, the first and second surface ply elements 110, 112, 114, 116 are respectively connected to each other, as a result of which the first and second cover layer elements 104, 106 respectively are produced.

In particular, each second surface ply element 112, 116 is joined to a first surface ply element 110, 114, in the present case by overlaying.

For example, a second surface ply element 112, 116 may be joined to a first surface ply element 110, 114 and, in particular, overlaid by a process that may comprise, for example, an adhesive bonding process and/or a tempering process and/or a pressurization process.

For example, a first and/or a second surface ply element 110, 112, 114, 116 may have at least one self-adhesive surface, in particular on one side, and/or an adhesive and/or an adhesive promoter may be applied, in particular on one side, to a first and/or a second surface ply element 110, 112, 114, 116 for the purpose of joining the surface ply elements 110, 112, 114, 116 to each other.

The first and the second surface ply element 110, 112, 114, 116 are now arranged directly next to each other and fastened to each other, resulting in the first and the second cover layer elements 104, 106.

The first and the the second cover layer element 104, 106 are now tempered and, in particular, pre-warmed and/or preheated before they are transferred into the mold unit 100 for manufacturing the multilayer component and arranged therein.

This can serve, for example, to improve joining of the plastic material 118 to the cover layer elements 104, 106 and/or to enable and/or promote, preferably simultaneous, shaping in the mold unit 100 during introduction of the plastic material 118.

The (optional) tempering of the first and the second cover layer element 104, 106 is preferably effected when the cover layer elements 104, 106 are arranged and/or in contact with each other.

Preferably, the second surface ply elements 112, 116 face toward each other.

For this purpose, the cover layer elements 104, 106 are transferred beforehand, for example manually and/or in an automated manner, into the said state in which they are arranged on and/or bear against each other.

Alternatively, the (optional) tempering of the first and the second cover layer element 104, 106 is effected in a singled state state, or individually and/or separately from each other, in which case the cover layer elements 104, 106 are then arranged on and/or placed against each other, for example manually and/or automatically.

The tempering may be effected, for example, by means of a tempering device, for example an oven, which may be part of the said production facility and/or may associated therewith.

Following the tempering process, the first and the second cover layer element 104, 106 are transferred into the mold unit 100, in the state in which they are arranged on and/or bear against each other, and are inserted therein.

The first and the second cover layer element 104, 106 are introduced in a horizontal or vertical alignment into the mold unit 100.

For example, the first and the second cover layer element 104, 106 are introduced into the mold unit 100 such that the gravitational direction 124 is oriented substantially perpendicularly with respect to a plane bounded by main directions of extent of the cover layer elements 104, 106, or lies substantially in this plane.

It is understood that the mold unit 100 is provided in a corresponding orientation for this purpose, for example in the production facility.

As can be seen in FIGS. 1 to 5 (and 8), in the present embodiment the first and the second cover layer element 104, 106 are introduced in a vertical alignment into the mold unit 100.

This introduction is, for example, insertion and/or suspension and/or setting of the cover layer elements 104, 106 in the mold unit 100.

The introduction is performed manually and/or in an automated manner.

Introduction is effected when the mold unit 100 is in an equipping state, in which the mold unit 100 is open, for example in an open state (not shown in the figures).

The first and the second cover layer element 104, 106 are thus provided in the mold unit 100 in the state in which they are arranged on and/or bear against each other.

Here, each first surface ply element 110, 114 is arranged on the mold side and each second surface ply element 112, 116 is arranged facing away from the mold unit 100, with the second surface ply elements 112, 116 of the cover layer elements 104, 106 being arranged facing toward each other and being arranged on and/or bearing against each other, for example directly.

As represented in FIG. 1, the mold unit 100 is now closed and is thus in the closed state.

The first and/or the second cover layer element 104, 106 is/are arranged adjacent to or directly on one or more mold elements 126 of the mold unit 100 and/or are supported and/or held directly on one or more mold elements 126 of the mold unit 100.

In particular, the mold unit 100 has one or more mold elements 126 that are realized as positioning elements 128, preferably as suspension pins and/or suspension mandrels, and/or separating elements 130, preferably separating pins.

A mold element 126 realized as a positioning element 128 preferably serves for positioning the cover layer elements 104, 106 in the mold unit 100.

A mold element 126 realized as a separating element 130 preferably serves for separating and/or spacing the cover layer elements 104, 106 from each other and/or relative to each other in the mold unit 100.

For example, the first and the second cover layer element 104, 106 are arranged and/or supported and/or held directly on a mold element 126 realized as a positioning element 128.

For this purpose, preferably realized in the first surface ply elements 110, 114 there is a through-hole 132 that corresponds to a respective through-hole 122 in the second surface ply elements 112, 116, such that their longitudinal center axes substantially coincide.

The through-holes 132 in the first surface ply elements 110, 114 may be provided, for example, in a separate method step in the ways previously described, and/or may be provided during the arranging of the cover layer elements 104, 106 in the mold unit 100, for example as a result of the first surface ply elements 110, 114 being penetrated by the positioning element 128.

These through-holes 122, 132, arranged so as to correspond to each other, serve to receive the mold element 126, realized as positioning element 128, that extends through these through-holes 122, 132 for the purpose of holding the cover layer elements 104, 106 in the mold unit 100 (cf. FIGS. 1 to 4).

Furthermore, the first and the second cover layer element 104, 106 are inserted and/or set and/or suspended in the mold unit 100, for example adjacent to mold elements 126 realized as separating elements 130 (cf. FIGS. 1 to 4).

The first and the second cover layer element 104, 106 are supported and/or held on the mold elements 126, 128, 130 preferably in a form-fitting and/or force-fitting manner.

As already described, the mold elements 126, 128, 130 can be brought into engagement with the through-holes 122, 132 for this purpose.

As can also be seen in FIG. 1, the positioning element 128 is arranged in a first mold section 134 of the mold unit 100, and the separating elements 130 are arranged in a second mold section 136 of the mold unit 100.

Accordingly, the mold unit 100 has two mold sections, here the first mold section 134 and the second mold section 136, by which a cavity 138 can be realized that substantially determines the outer contour of the multilayer component 102.

As previously described, the mold unit 100 is movable between an open state, or the open state, and a closed state, or the closed state, this preferably being effected by spacing the mold section 134, 136 from each other and by bringing the mold sections back into engagement 134, 136 with each other.

For example, the mold unit 100 can be opened and/or closed along direction of actuation 140, for example by means of an actuating device, not shown in the figures, that may for example be part of a, or the, production facility, for receiving and/or opening and/or closing a, or the, mold unit 100.

For example, the direction of actuation 140 is oriented transversely and in particular perpendicularly with respect to the direction of gravity 124.

The mold elements 126, 128, 130 extend into the cavity 138 to allow the cover layer elements 104, 106 to be arranged thereon.

Furthermore, the mold elements 126, 128, 130 can be moved into the cavity 138 and/or moved out of the cavity 138.

To equip the mold unit 100 (cf. FIG. 1), the mold elements 126, 128, 130 can be or are actively moved into the cavity 138 by means of a positioning means of the mold unit 100 that us not shown in the figures.

For example, the positioning means is a pneumatic and/or hydraulic and/or electrical positioning means, by means of which the mold elements 126, 128, 130 can be moved pneumatically and/or hydraulically and/or electrically.

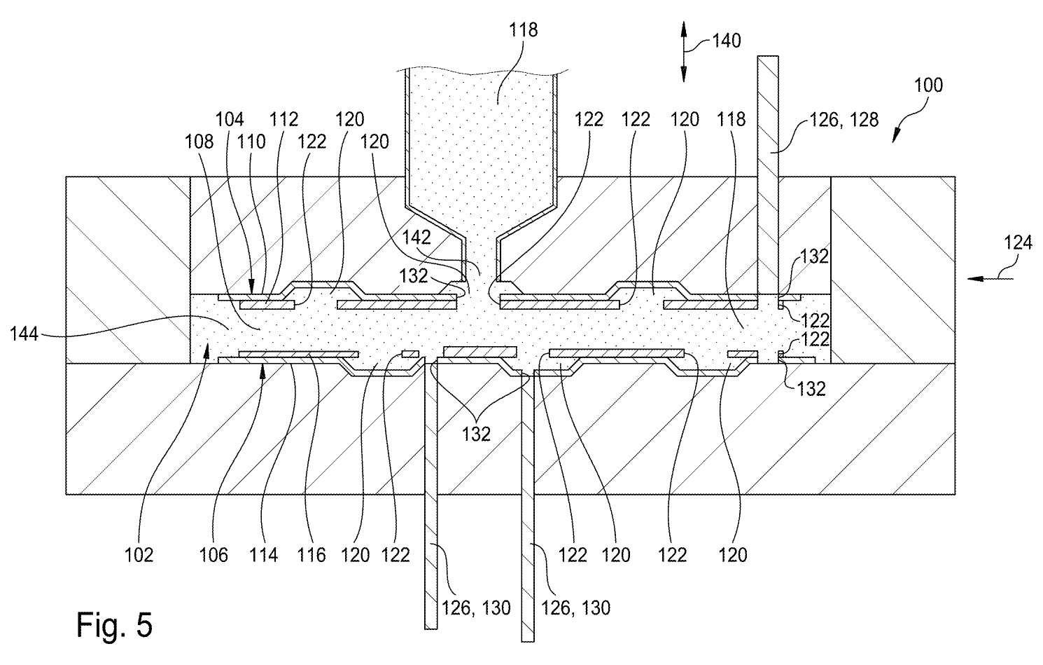

The mold elements 126, 128, 130 can also be actively moved out of the cavity 138 (cf. FIG. 5), which can be initiated by said positioning means.

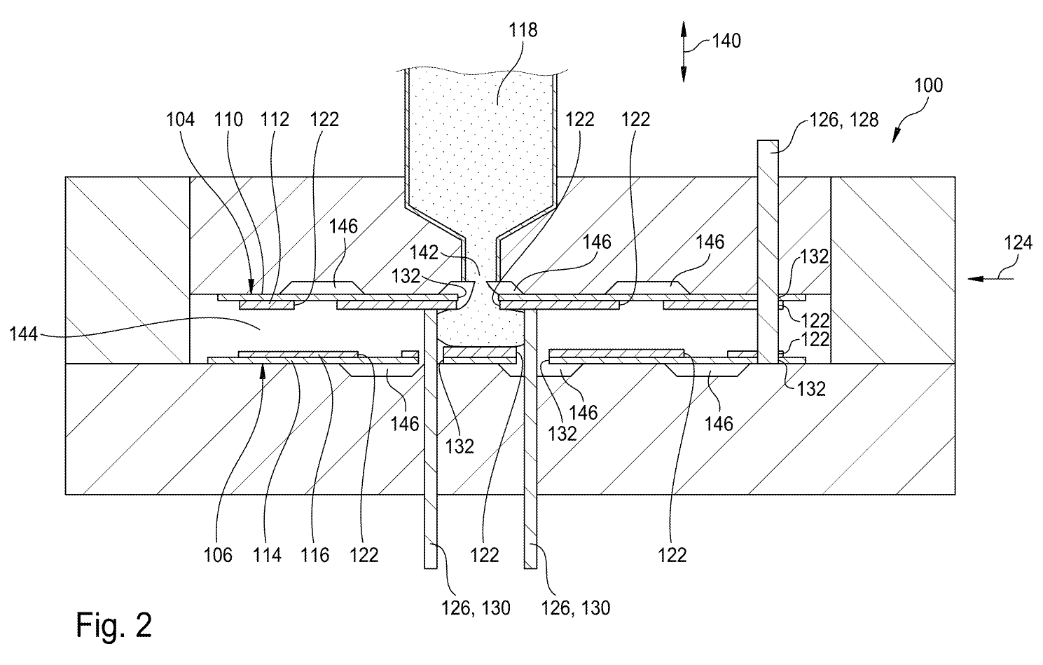

After the first and the second cover layer element 104, 106 have been provided in the mold unit 100, the plastic material 118 is introduced between the first and the second cover layer element 104, 106 and preferably injected and/or sprayed in (cf. FIG. 2).

This is preferably used for producing the core element 108 of the multilayer component 102.

The injected and/or sprayed-in plastic material 118 is, for example, a plastic material 118, heated above an associated softening temperature and preferably melted, that can be or is provided, for example, by means of a provisioning device of, for example, the production facility.

In particular, it may be introduced by means of injection molding.

As already described, in the present case the plastic material 118 is a thermoplastic plastic material, for example a polyethylene, polypropylene, polyphenylene ether, polyphthalamide, polyphenylene sulfone, polyether ether ketone, polysulfone, polyamide, polybutylene terephthalate and/or polystyrene. In the present exemplary embodiment, this may preferably be polyethylene.

As can be seen in particular in FIG. 2, the plastic material 118 is injected and/or sprayed in via a feed-in opening 142 of the mold unit 100, for example injection and/or spray-in nozzle.

Here, the first cover layer element 104 has mutually corresponding through-holes 122, 132 in the surface ply elements 110, 114, through which the plastic material 118 coming out of the said feed-in opening 142 of the mold unit 100 can be or is introduced, in this case injected and/or sprayed in, between the cover layer elements 104, 106. The through-hole 132 in the first surface ply element 110 is introduced in advance in the manner already described and/or in a separate process step, for example with the other through-holes 132 in the first surface ply elements 110, 114.

Here, the first and the second cover layer element 104, 106 are spaced apart from each other during the injecting and/or spraying-in of the plastic material 118, and/or by the injecting and/or spraying-in of the plastic material 118.

The state in which the cover layer elements 104, 106 are arranged on and/or bear against each other is thus converted into a spaced-apart state of the cover layer elements 104, 106, which can be seen in FIG. 2.

This spacing apart of the cover layer elements 104, 106 from each other is made possible in particular by the tool elements 126 realized as separating elements 130.

Prior to the injecting and/or spraying-in process, the separating elements 130 have been and/or are moved against the first and/or the second cover layer element 104, 106 in order to locally fix and/or keep fixed one of the first and/or the second cover layer element 104, 106 in the mold unit 100, such that the spacing of the cover layer elements 104, 106 from each other is rendered possible and/or can be induced.

Due to the plastic material 118 passing between the cover layer elements 104, 106 via the feed-in opening 142 and through the through-holes 122, 132 in the first cover layer element 104, and the first cover layer element 104 being fixed in the cavity 138 by means of the mold elements 126, 130, or separating elements 130, the cover layer elements 104, 106 become spaced apart from each other, as a result of the introduced plastic material 118.

For example, due to the first cover layer element 104 being supported by means of the tool elements 126, 130, or separating elements 130, in order to locally fix and/or hold this cover layer element 104 fixed in the mold unit 100, the second cover layer element 106 can be moved in the mold unit 100 for the purpose of the spacing of the cover layer elements 104, 106 from each other by the introduced, in particular injected and/or sprayed-in, plastic material 118.

As can be seen from FIG. 2, the plastic material 118 is introduced through the feed-in opening 142 into the cavity 138 in a direction that is oriented counter to a bearing force of the mold elements 126, 130 or separating elements 130, that is exerted upon the first cover layer element 104.

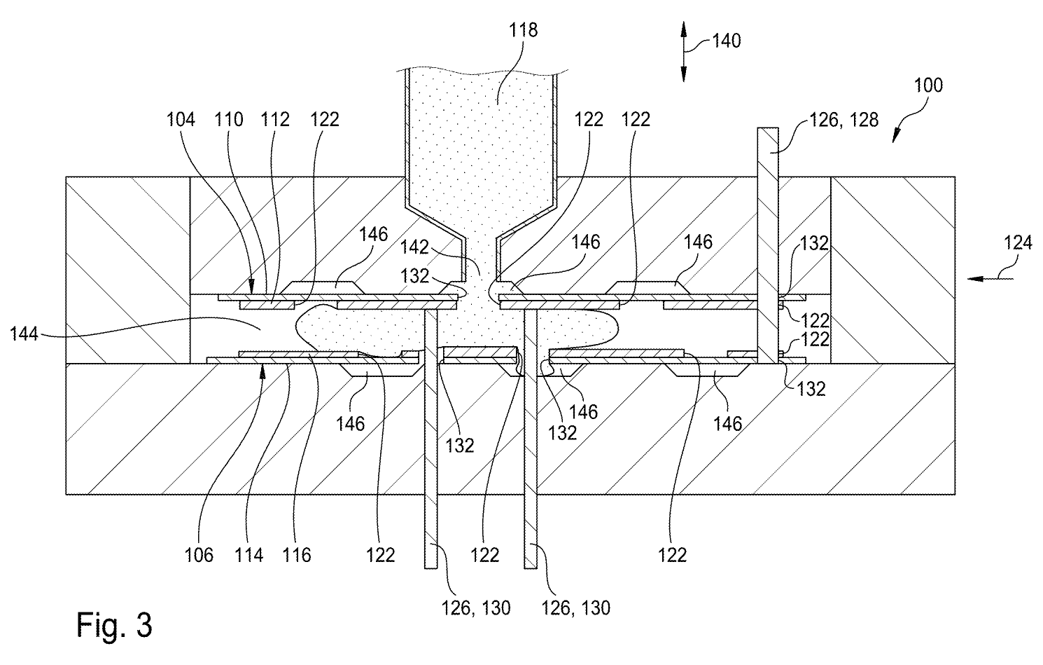

Due to an introduction pressure building up and/or prevailing during the introduction of the plastic material 118 in the cavity 138, the second cover layer element 106 has been moved against the second mold section 136, such that the cover layer elements 104, 106 are now spaced apart (cf. FIG. 2), and the plastic material 118 can be distributed between them to realize the core element 108 (cf. FIG. 3).

The plastic material 118 injected and/or sprayed-in between the cover layer elements 104, 106 thus realizes the core element 108.

For example, the plastic material 118 injected and/or sprayed-in between the cover layer elements 104, 106 initially forms the core element 108.

During the injecting/or spraying-in of the plastic material 118, the plastic material 118 is pressed through the through-holes 122 of the second surface ply elements 112, 116 and thereby introduced between the respective first and the respective second surface ply element 110, 112, 114, 116, and/or brought into contact with the respective first surface ply elements 110, 114 (cf. FIG. 5).

As a result, the plastic material 118 realizes respective fixing sections 120 in the region of the respective through-holes 122 of the second surface ply elements 112, 116 (cf. FIG. 5).

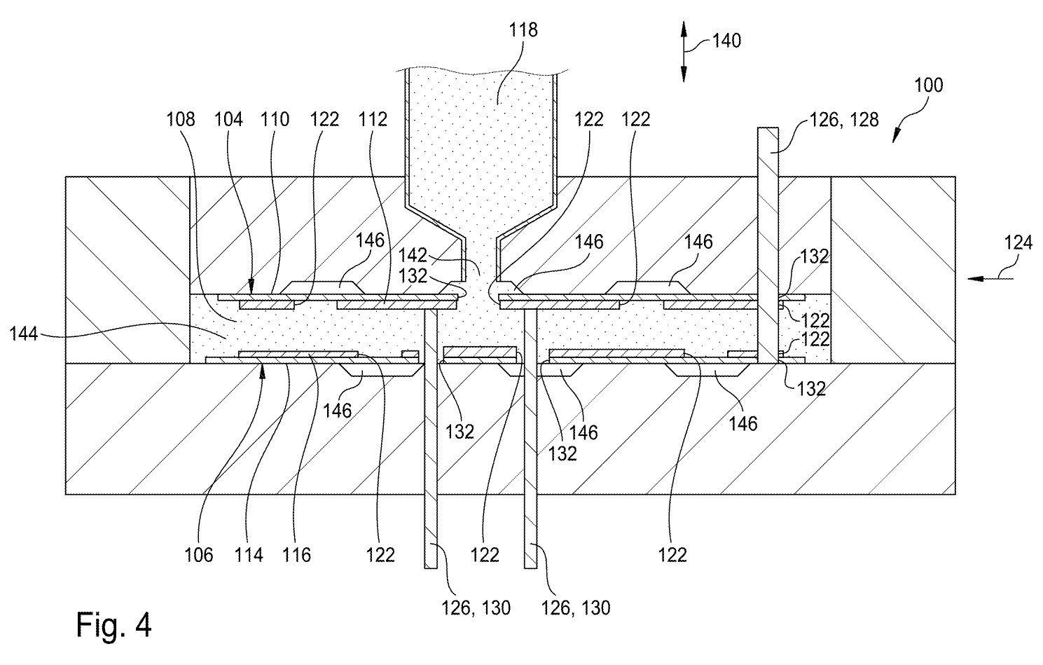

For example, this may preferably be effected after an intermediate space 144 between the cover layer elements 104, 106, and in particular the second surface ply elements 112, 116, in which the core element 108 is formed, is filled with plastic material 118 to realize the core element 108 (cf. FIG. 4).

The fixing sections 120 serve to fix the first and/or the second surface ply elements 110, 112, 114, 116 to the core element 108.

Here, the first surface ply elements 110, 114 in the multilayer component 102 are preferably arranged on the outside and/or directed outwardly.

For example, the first surface ply elements 110, 114 in the multilayer component 102 are respectively an uppermost and a lowermost layer.

As can be seen in particular in FIG. 5, a fixing section 120 realizes a form-fit connection to a second surface ply element 112, 116.

Furthermore, a fixing section 120 realizes a form-fit and/or materially bonded connection to a first surface ply element 110, 114.

A fixing section 120 corresponds to at least one through-hole 122 and/or can be or is assigned to at least one through-hole 122, for example through which plastic material 118 was introduced between the first and the second surface ply element 110, 112, 114, 116 and/or was brought into contact with the first surface ply element 110, 114. It is also conceivable for a fixing section 120 to correspond to two or more of the through-holes 122 and/or to be assignable or assigned to them.

Preferably, a fixing section 120 has at least one retaining region that is oriented transversely and in particular perpendicularly with respect to a direction of extent of a corresponding and/or assignable and/or assigned through-hole 122.

The at least one retaining section serves to enable and/or realize the said form-fit connection to the second surface ply element 112, 116 and/or the said form-fit and/or materially bonded connection to the first surface ply element 110, 114.

In the present embodiment example, a fixing section 120, and, for example its retaining section, is substantially mushroom-like and/or mushroom-shaped and/or is substantially rivet-like and/or rivet-shaped.

Preferably, a fixing section 120, and for example its retaining region, engages behind a second surface ply element 112, 116 with respect to the intermediate space 144, preferably after the plastic material 118 has been introduced into the intermediate space 144 between the first and the second cover layer element 104, 106 and when this space has been filled with plastic material 118.

Here, the fixing section 120, and for example its retaining region, is arranged at least partially on and/or at a lateral face of a second surface ply element 112, 116 that faces away with respect to the intermediate space 144.

As can be seen in FIGS. 1 to 5, the shape of the fixing sections 120, and for example their retaining regions, is influenced and/or determined by the cavity 138 of the mold unit 100.

For this purpose, the cavity 138 has a plurality of cavity recesses 146 that substantially determine the outer contour of the fixing sections 120.

The cavity recesses 146 recess along a direction that is oriented transversely, and in particular perpendicularly, with respect to a longitudinal center plane of the cavity 138 of the mold unit 100.

In the present case, the cavity recesses 146 recess along the direction of actuation 140.

As already described, during the injecting/or spraying-in of the plastic material 118, the plastic material 118 is pressed through the through-holes 122 of the second surface ply elements 112, 116, as a result of which the plastic material 118 realizes respective fixing sections 120 in the region of the respective through-holes 122 of the second surface ply elements 112, 116 (cf. FIG. 5).

Here, the respective first surface ply elements 110, 114 are pressed into the cavity recesses 146 in the region of the said through-holes 122 by the introduced plastic material 118 and thereby stretched and/or plastically deformed into the cavity recesses 146.

One or more fixing sections 120 thus have sections of the first surface ply elements 110, 114 on the outside.

Furthermore, in these regions the plastic material 118 is materially bonded to the first surface ply elements 110, 114.

When the cavity 138 and the cavity recesses 146 have been filled with plastic material 118, preferably when the plastic material 118 has not yet cooled and hardened, the mold elements 126, 128, 130 are moved out of the cavity 138 (cf. FIG. 5), preferably by the positioning means already described.

Due to the injection pressure of the plastic material 118 prevailing in the cavity 138, the volume that is released by the mold elements 126, 128, 130 is likewise filled with plastic material 118.

When the core element 108 and the fixing sections 120 have been realized, preferably sufficiently cooled and hardened, the mold unit 100 can be brought back into the open state, such that the multilayer component 102 produced can be ejected and/or removed from the mold unit 100, for example manually and/or in an automated manner.

The first surface ply elements 110, 114 of a cover layer element 104, 106 are arranged on the outside and/or directed outwardly in the multilayer component 102.

The first surface ply elements 110, 114 form an uppermost and a lowermost layer in the multilayer component 102.

In particular, the first surface ply elements 110, 114 in the multilayer component 102 form an outer peripheral surface of the multilayer component 102 and/or at least a part thereof.

New cover layer elements 104, 106 can then be provided in the mold unit 100 for the manufacture of a further multilayer component 102.

With reference to FIG. 6, a multilayer component 102 is provided, for example for a battery housing, that can be or is produced by means of the method of FIGS. 1 to 5.

All the structural and functional features associated with the method of FIGS. 1 to 5 may also be included in the multilayer component 102 of FIG. 6, and the features, embodiments and advantages associated therewith may accordingly likewise be be included and and achieved.

As can be seen in particular in FIG. 6, the first surface ply elements 110, 114 are arranged on the outside and in an exposed manner in the multilayer component 102.

The first surface ply elements 110, 114 preferably serve as a protective element, for example for corrosion protection, of the multilayer component 102.

The second surface ply elements 112, 116 are arranged on the inside of the multilayer component 102, and not exposed.

The second surface ply elements 112, 116 preferably serve as a stiffening and/or reinforcing element, for example for load absorption and/or load distribution in the multilayer component 102.

With reference to FIG. 7, a multilayer component 102, for example for a battery housing, is provided according to a further exemplary embodiment.

The exemplary embodiment of the multilayer component 102 of FIG. 7 is configured and designed substantially like the multilayer component 102 of FIG. 6, and can be or is manufactured substantially by means of the method of FIGS. 1 to 5, such that only the differences are described below.

For the multilayer component 102 of FIG. 7, the through-holes 122 are punched in the second surface ply elements 112, 116.

In the punching of the through-holes 122, in the present exemplary embodiment a hole ridge 148, for example circumferential, is realized in the peripheral region of each through-hole 122.

Along a punching direction, each through-hole 122 has, for example, a circumferential radius region 150 in the upper peripheral region and the hole ridge 148 in the lower peripheral region.

Furthermore, the mold unit 100 by means of which the multilayer component 102 of FIG. 7 can be or is manufactured has no cavity protrusions and/or cavity recesses 146.

When the plastic material 118 is now introduced into the through-holes 122, these are filled, with the plastic material 118 coming between the first and second surface ply elements 110, 112, 114, 116 in the region of the radius region 150 and realizing the fixing sections 120 there.

As can be seen in FIG. 7, a fixing section 120, and for example its retaining region, is substantially mushroom-like and/or mushroom-shaped and/or substantially rivet-like and/or rivet-shaped.

Furthermore, each fixing section 120 also engages behind the respective second surface ply element 112, 116 and is materially bonded to the respective first surface ply element 110, 114.

Furthermore, the inwardly directed hole ridges 148 may provide a reliable and/or stronger connection between the core element 108 and the second surface ply elements 112, 116.

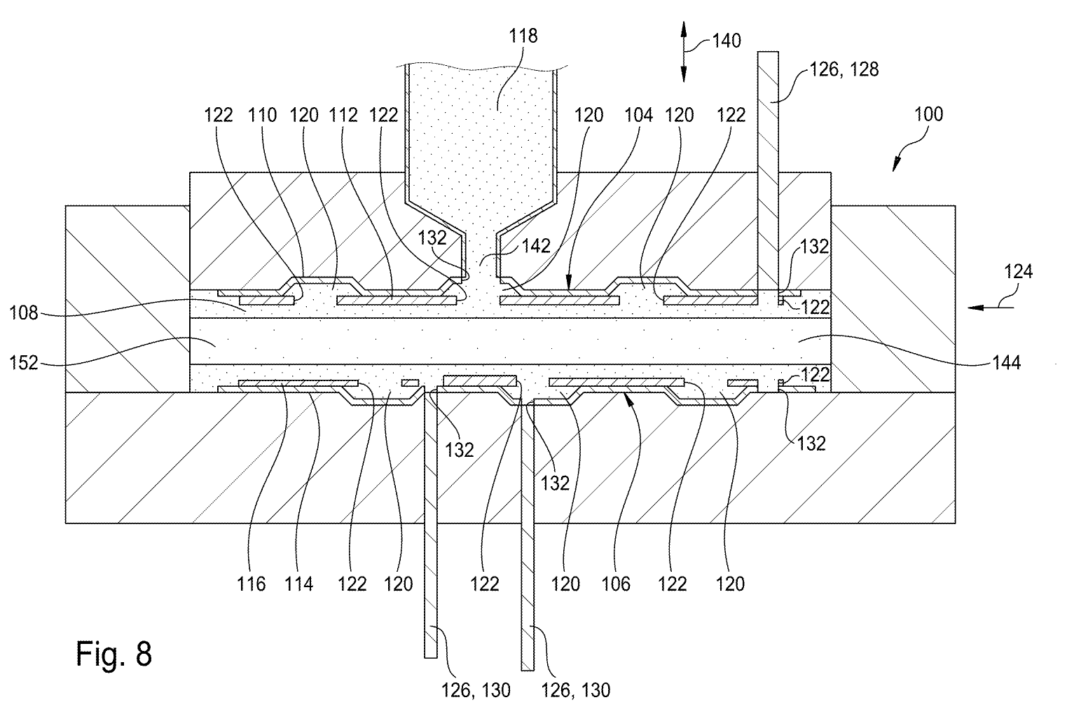

With reference to FIG. 8, a method for manufacturing a multilayer component 102 according to another embodiment is provided.

The exemplary embodiment of the method of FIG. 8 is configured and designed substantially like the method of FIGS. 1 to 5, such that only the differences are described below.

However, the method of FIG. 8 further comprises:
cooling the introduced plastic material 118 and/or allowing it to cool; and
then moving the mold sections 134, 136 away from each other for the purpose of realizing a foamed intermediate layer 152 of the multilayer component 102.

The cooling and/or allowing to cool preferably relates only to peripheral regions of the core element 108 and to regions adjacent to the second surface ply elements 112, 116.

For example, the foamed intermediate layer 152 is arranged and/or realized in the cavity 114 and in the core element 108.

For example, the foamed interlayer 152 is arranged and/or realized along a or the longitudinal center plane of the cavity 138 of the mold unit 100.

As can be seen in FIG. 8, the multilayer component 102 has such an intermediate layer 152, which is arranged between the cover layer elements 104, 106 and is present in the core element 108.

In particular, this intermediate layer 152 is bordered above and below by non-foamed plastic material 118 in the core element 108.

In the present case, the multilayer component 102 thus has three intermediate layers, which form the core element 108.

The foamed intermediate layer 152 has, for example, a first material state, the first material state being a foamed state and/or having a foam phase.

The respective intermediate layer above and below the foamed intermediate layer 152 has, for example, a second material state, the second material state being a non-formed state and/or having substantially no foam phase.

Furthermore, the first material state has a lesser density than the second material state and/or the second material state has a greater density than the first material state.

It may be provided, for example, that between the said intermediate layers having differing material states there is, in particular, a continuous transition between the material states. For example, in the continuous transition, a density may increase or decrease continuously, and/or a foam phase may increase or decrease continuously.

It may additionally or alternatively be provided that a gas and/or a gas mixture is supplied to the plastic material 118 during introduction of the plastic material, which is thus foamed. For example, it may be provided that a certain material state, in particular the first material state already described, may be enabled and/or realized in this way. In this case, the mold sections 134, 136 would not have to be moved apart.

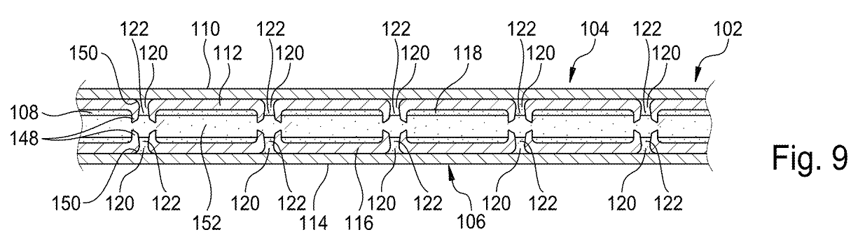

With reference to FIG. 9, a multilayer component 102, for example for a battery housing, is provided according to a further exemplary embodiment.

The exemplary embodiment of the multilayer component 102 of FIG. 9 is configured and designed substantially like the multilayer component 102 of FIG. 7, and can be or is manufactured by means of the method of FIG. 8.

This is therefore a combination of the embodiments of FIGS. 7 and 8, such that reference is otherwise made to the corresponding description.

### LIST OF REFERENCE DESIGNATIONS

100 mold unit

102 multilayer component

104 first cover layer element

106 second cover layer element

108 core element

110 first surface ply element for the first cover layer element

112 second surface ply element of the first cover layer element

114 first surface ply element of the second cover layer element

116 second surface ply element of the second cover layer element

118 plastic material

120 fixing section

122 through-hole in the second surface ply element

124 direction of gravity

126 mold element

128 positioning element

130 separating element

132 through-hole in the first surface ply element

134 first mold section

136 second mold section

138 cavity

140 direction of actuation

142 feed-in opening

146 cavity recess

148 hole ridge

150 radius region

152 foamed intermediate layer

1. A method for producing a multilayer component, the method comprising at least:
providing a first and a second cover layer element in a mold unit, at least one of the cover layer elements having a first and a second surface ply element that are arranged next to and/or fastened to each other, or are directly arranged next to and/or fastened to each other, there being one or more through-holes realized in the second surface ply element; and
introducing a plastic material between the first and the second cover layer element for the purpose of producing a core element of the multilayer component, wherein
during the introduction of the plastic material, plastic material being introduced through the one or more through-holes between the first and the second surface ply element and/or being brought into contact with the first surface ply element, as a result of which the plastic material in the region of the one or more through-holes of the second surface ply element realizes a respective fixing section for fixing at least one of the surface ply elements to the core element.

2. The method as claimed in claim 1, which comprises that a fixing section realizes a form-fit connection to the second surface ply element; and/or the fixing section realizes a form-fit and/or materially bonded connection to the first surface ply element; and/or the second surface ply element is provided with an adhesion promoter and the fixing section realizes a materially bonded connection to this second surface ply element.

3. The method as claimed in claim 1, which comprises that, following the introduction of the plastic material, an intermediate space between the first and the second cover layer element is filled with plastic material, and a fixing section engages behind the second surface ply element with respect to the intermediate space, or engages behind the second surface ply element with respect to the intermediate space and is arranged at least partially on and/or at a lateral face of the second surface ply element that faces away with respect to the intermediate space.

4. The method according to claim 1, which comprises that the mold unit has at least two mold sections by which a cavity can be realized that determines the outer contour for the multilayer component, and the cavity has one or more cavity protrusions and/or one or more cavity recesses that substantially determine the outer contour for the fixing sections.

5. The method according to claim 1, which comprises that, before the first and the second cover layer element are provided in the mold unit, the second surface ply element is joined, or joined by layering, to the first surface ply element, or the second surface ply element is joined, or joined by layering, to the first surface ply element by means of and/or during the introduction of the plastic material.

6. The method according to claim 1 which comprises that the first surface ply element at least partially comprises and/or is formed from a material that corresponds substantially to the plastic material and/or that can be joined to the plastic material by material bonding.

7. The method according to claim 1, which comprises that at least one of the following applies:
a) the second surface ply element is realized as a sheet element and/or comprises such a sheet metal element, wherein the sheet element of the second surface ply element is a metallic sheet, or a steel sheet or a sheet containing aluminum; and/or
b) the first surface ply element is realized as a sheet element or film element and/or comprises such an element, wherein the sheet element of the first surface ply element is a plastic sheet, or a thermoplastic sheet, and/or a fiber composite sheet, or an organic sheet and/or tape and/or sheet element formed from tapes, or the film element of the first surface ply element is a plastic element, or a thermoplastic film element.

8. The method according to claim 1, which comprises that at least one of the following applies:
a) the plastic material is a thermoplastic and/or thermosetting plastic material; and/or
b) a gas and/or a gas mixture is supplied to the plastic material during the introduction of the plastic material, which is thus foamed.

9. The method according to claim 1, which comprises that the first and the second cover layer element are arranged on and/or bear against each other, or are directly arranged on and/or bear against each other, when being provided in the mold unit; and the first and the second cover layer element are spaced apart from one other before the introduction of the plastic material and/or during the introduction of the plastic material and/or by the introduction of the plastic material.

10. The method as claimed in claim 9, which comprises that at least one of the following applies:
a) the first and the second cover layer element are spaced apart before the introduction of the plastic material and/or during the introduction of the plastic material and/or by the introduction of the plastic material, enabled by one or more mold elements of the mold unit; and/or
b) the first and/or the second cover layer element is/are arranged, or supported, or directly arranged or directly supported, adjacent to one or more mold elements of the mold unit, before the plastic material is introduced; and/or
c) the plastic material is introduced between the first and the second cover layer element, with the first and/or the second cover layer element being supported, prior to the introduction, by means of one or more mold elements of the mold unit for the purpose of the spacing apart the cover layer elements from one other caused by the introduced plastic material; and/or
d) the first and the second cover layer element are provided in a cavity of the mold unit that determines the outer contour for the multilayer component, and one or more, or all, mold elements of the mold unit are moved out, or actively and/or passively moved out, of the cavity of the mold unit during the introduction, by means of a positioning means and/or as a result of by the introduced plastic material.

11. The method according to claim 1, which comprises that, before the first and the second cover layer element are provided in the mold unit, the first and the second cover layer element are tempered, or preheated, and/or the first and the second cover layer element are tempered, or preheated, jointly when arranged on and/or bearing against each other, or when directly arranged on and/or bearing against each other, or the first and the second cover layer element are tempered, or preheated, and then arranged and/or placed next to each other, or then directly arranged and/or placed next to each other.

12. A multilayer component, for a battery housing and/or an underride guard system, the multilayer component being manufactured by means of the method according to claim 1, the multilayer component being provided that the multilayer component comprises at least the following:
a first and a second cover layer element, at least one of the cover layer elements having a first and a second surface ply element that are arranged on and/or fastened to each other, or are directly arranged on and/or fastened to each other, with one or more through-holes being realized in the second surface ply element;
a core element that is arranged between the first and the second cover layer element and that is produced by means of introduction of a plastic material between the first and the second cover layer element; and
at least one fixing section for fixing at least one of the surface ply elements to the core element, the at least one fixing section being arranged in the region of the one or more through-holes of the second surface ply element and being produced by means of introduction of a plastic material between the first and the second cover layer element that during the introduction process is introduced between the first and the second surface ply element through the one or more through-holes and/or is brought into contact with the first surface ply element.

13. The multilayer component as claimed in claim 12, which comprises that the first surface ply element in the multilayer component is arranged on the outside, or exposed, and/or the second surface ply element in the multilayer component is arranged on the inside, or not exposed.

14. A battery housing, the battery housing comprising said multilayer component as claimed in claim 12, the battery housing being provided that the multilayer component is realized as a tray element and/or as an underride guard element.

15. A mold unit for producing a multilayer component, or said multilayer component as claimed in claim 12, the mold unit being able to perform said method.
